(19) United States
(12) Patent Application Publication
(10) Pub. No.: US 2012/0219788 A1
(43) Pub. Date: Aug. 30, 2012

(54) HIGHLY REFRACTIVE, SCRATCHPROOF TIO2 COATINGS IN MONO- AND MULTILAYERS

(75) Inventors: Karlheinz Hildenbrand, Owingen (DE); Friedrich-Karl Bruder, Krefeld (DE)

(73) Assignee: Bayer MaterialScience AG, Leverkusen (DE)

(21) Appl. No.: 13/502,160

(22) PCT Filed: Oct. 11, 2010
(86) PCT No.: PCT/EP2010/065204

§ 371 Date: May 14, 2012

(30) Foreign Application Priority Data
Oct. 16, 2009 (DE) 102009049604.1

(51) Int. Cl. G11B 7/241; B32B 27/14; B05D 3/02; B05D 3/06; C09D 133/08; B32B 18/00; B32B 5/16; B82Y 30/00

(52) U.S. Cl. 428/328; 428/702; 428/332; 428/412; 428/480; 428/522; 428/523; 427/385.5; 427/487; 522/33; 522/18; 977/773

(57) ABSTRACT

The invention relates to coated products containing a substrate (S) provided with a coating consisting of a single high refractive index and scratch-resistant layer (A) or provided with a multilayer structure in which layers (A) alternate with lower refractive index layers (B), wherein the layers (A) are characterised in that they contain particularly finely divided TiO₂ nanoparticles.

The invention relates to coated products containing a substrate (S) provided with a coating consisting of a single high refractive index and scratch-resistant layer (A) or provided with a multilayer structure in which layers (A) alternate with lower refractive index layers (B), wherein the layers (A) are characterised in that they contain particularly finely divided TiO₂ nanoparticles. The coatings containing the layer (A) can be produced by a process which enables the nanoparticles to be deposited without agglomeration. Accordingly, the invention further provides a process for the production of the products provided with a single layer or with multilayers and the use thereof, for example as a cover layer in optical data storage media or as IR reflective coatings.

Coatings having a high refractive index n (high refractive index (HRI) layers, also referred to as HRI layers hereinbelow) are known from various applications, for example in optical lenses or planar waveguides. The expression “refractive index” is here synonymous with the “real part of the complex refractive index”, and the two expressions are used synonymously in the present application and are denoted n. Coatings having high refractive indices can in principle be produced by various methods. In a purely physical method, high refractive index metal oxides, such as, for example, TiO₂, Ta₂O₅, CeO₂, Y₂O₃, are deposited under a high vacuum by plasma processes in the so-called “sputtering process”. While refractive indices of over 2.0 in the visible wavelength range can thereby be achieved without difficulty, the process is relatively complex and expensive.

U.S. Pat. No. 6,777,070 B1 describes an antireflection material and a polarising film, wherein the scratch-resistant coating consists of three components: 1. a fluorine-containing methacrylate polymer, 2. a polymer of urethane acrylate and ultrafine particles, and 3. a resin with surface-treated titanium oxide particles. A mixture of titanium dioxide and zirconium dioxide is accordingly used in the examples. The present coated product contains only titanium dioxide nanoparticles in the scratch-resistant layer.

DE 1,982,3732 A1 describes a process for the production of optical multilayer systems, wherein inter alia a flowable composition containing nanoscale inorganic solids particles is applied to a glass substrate. In the present application, the substrates are made of polymeric material.

Chem. Mater 2001, 13, 1137-1142 describes the production of optical thin films from high refractive index trialkoxysilane-capped PMMA-titanium hybrid as well as inter alia their transmission. The coating is a scratch-resistant coating on potassium bromide pellets. Polycarbonate as substrate material is not mentioned.

U.S. Pat. No. 6,777,706 B1 describes an optical product which contains a layer of organic material, wherein the layer contains light-permeable nanoparticles. The content of nanoparticles, inter alia TiO₂, in the cured layer can be from 0 to 50 vol.%. The coated product according to the present invention contains an amount of >58 wt.% titanium dioxide in the coating.

From EP 0964019 A1 and WO 2004/009659 A1 there are known organic polymers, for example sulfur-containing polymers or halogenated acrylates (tetrabromophenyl acrylate, Polyscience Inc.), which inherently have a higher refractive index than conventional polymers and which can be applied to surfaces by simple methods from organic solutions by conventional coating processes. However, the refractive indices are here limited to values up to about 1.7, measured in the visible wavelength range.

A further process variant which is becoming increasingly important is based on metal oxide nanoparticles which are incorporated into organic or polymeric binder systems. The corresponding nanoparticle-polymer hybrid recipes can be applied to various substrates in a simple manner and inexpensively, for example by means of spin coating. The achievable refractive indices are conventionally between the sputter surfaces mentioned at the beginning and the layers of high refractive index polymers. As the nanoparticle contents increase, increasing refractive indices can be achieved. For example, US 2002/176169 A1 discloses the production of nanoparticle-acrylate hybrid systems, wherein the high refractive index layers contain a metal oxide, such as, for example, titanium oxide, indium oxide or tin oxide, as well as a UV-crosslinkable binder, for example based on acrylate, in an organic solvent. After spin coating, evaporation of the solvent and UV irradiation there are obtained corresponding coatings for optical films/foils which contain a scratch-resistant coating, an HRI layer (I) in a thickness of from 30 to 120 nm and having a desired refractive index of from 1.70 to 1.95, a layer (II) in a thickness of from 5 to 70 nm and having a refractive index of from 1.60 to 1.70, and an LRI layer of a siloxane-based polymer. These foils are said to be suitable as antireflection layers. Although a desired refractive index range of up to 1.95 is mentioned for the HRI layer (I), there is no indication or example as to how such a layer could be produced. The examples describe the production of HRI layers (I) which have refractive indices n of only 1.71 and 1.72 (according to the manufacturer of the TiO₂-containing coating solution that is used, refractive indices of only max. 1.59 can be achieved). No information is given regarding the imaginary part k of the refractive index, it also depends, as described below, on the size of the nanoparticles. Therefore, the layers having higher refractive indices claimed in this application are to be regarded merely as a desideratum, and the disclosure does not satisfy the requirement for a process for the production of such high refractive index layers.

In WO-A 2008/040439, coated products containing a substrate (S) and a coating (A) produced from a water-containing nanoparticle suspension are described. The coatings (A) are characterised in that they have a real part n of the complex refractive index of at least 1.70, an imaginary part k of the complex refractive index of not more than 0.016, a surface roughness as the Ra value of less than 20 nm and a scratch resistance of less than or equal to 0.75 μm scratch depth, wherein the real part and the imaginary part of the refractive index were measured at a wavelength of from 400 to 410 nm (i.e. in the wavelength range of blue laser) and the surface roughness as the Ra value was measured by means of AFM (atomic force microscopy). Such HRI coatings can be used as the topmost layer in optical data storage media (ODS), the high refractive index allowing the coupling of light in the evanescent field of a near-field lens (solid immersion lens, SIL). However, the performance, in particular the storage capacity, of such optical data storage media is better, the higher the real part n of the refractive index and the lower the imaginary part k (k value) of the refractive index of the HRI layer. The k value is related to the decay constant of the light intensity a as follows:

$$k = \frac{λ \cdot α}{4 π} .$$

The decay constant α is in turn dependent on the absorption and the scatter in the refracting medium. In the case of nanoparticle-containing systems in particular, k and α can be dominated in the visible wavelength range of from 400 to 800 nm by the scatter if the primary nanoparticles are too large or nanoparticles agglomerate to form larger particles, even if there is no molecular absorption in that spectral range. A low k value accordingly describes a medium in which light scatter and absorption are low and which has good transmission properties.

One step of the production process for such coatings from EP-A 2008/040439 is the partial exchange of the water of an aqueous nanoparticle suspension for organic solvent.

If the water content is not adjusted exactly, this process leads to agglomeration of the nanoparticles and accordingly to layers having reduced transmission (higher k values). In the course of further investigations it was found that agglomerations cannot be avoided in particular in the solvent exchange of water for organic solvent in suspensions containing TiO₂ nanoparticles. Layers having a real part n of the complex refractive index of at least 1.85 and an imaginary part k of the complex refractive index of not more than 0.01 (measured at a wavelength of from 400 to 410 nm) can therefore not be achieved with HRI layers produced according to EP-A 2008/040439.

The combination of HRI layers with other coatings having a markedly lower refractive index (low refractive index (LRI) layers) leads to double-refracting multilayers (alternating sequence of low and high refractive index layers). As a result, it is possible to produce coatings having reflective properties for electromagnetic radiation, for example in the visible part of the solar spectrum or in the IR heat radiation range. The principles of these developments are described in U.S. Pat. Nos. 3,610,729, 5,094,788, 5,122,905, 5,122,906, 5,269,995 and 5,389,324 of Dow. Films having IR-reflecting properties are offered, for example, by 3M under the name “Prestige Series Films”. These are individual laminated layers of films having different refractive indices, for example of polyester and polyacrylate films, whose layer thicknesses are in the region of ¼ of the IR radiation to be reflected, that is to say about 250 nm. Because of the small difference in refractive index of not substantially more than 0.1 (polyacrylate: n˜1.5 and polyester: n˜1.6), a very large number (about 200) of HRI/LRI layers is required in order to obtain IR reflection values of about 90%. With layer sequences whose refractive indices differ more greatly, the number of layer sequences could be markedly reduced on the basis of theoretical calculations. Conventional coating recipes, for example based on acrylate, normally have a real part of the refractive index in the region of about n=1.5.

For that reason, the suitability of an HRI layer for an HRI/LRI multilayer structure is higher, the higher its refractive index. Efficient reflective properties could thus be possible with a markedly smaller number of layer sequences.

There is therefore a need for HRI layers for substrates such as glass, quartz or organic polymers which have improved complex refractive indices as compared with the prior art, determined by the fact that the real part n of the complex refractive index is higher and at the same time the imaginary part k is lower, and at the same time in which values for surface roughness (“Ra value”, measured by means of AFM (atomic force microscopy)) and scratch resistance (determined by measuring the resulting scratch depth when a diamond needle having a tip radius of 50 μm is moved over the coating at a speed of 1.5 cm/s and with an applied weight of 40 g) are at least at a comparable level. It is additionally to be possible to produce the layers by a simple process.

With regard to novel high refractive index HRI layers, it has now been found, surprisingly, that by integrating commercially available, anhydrous, organically modified TiO₂ nanoparticles having a d₁₀₀ value of ≦ about 100 nm into UV-crosslinkable lacquer formulations known per se, it is possible to produce high refractive index lacquer layers (layer (A)) having a real part a of the complex refractive index greater than 1.85, preferably >1.90 and particularly preferably greater than 1.92, and an imaginary part k of the complex refractive index less than 0.01, preferably <0.008 and particularly preferably <0.005 (measured at a wavelength of 405 nm). The HRI layers according to the invention have a layer thickness of >120 nm, in particular ≧125 nm and ≧150 nm. Even at larger layer thicknesses, for example ≧200 nm, ≧300 nm and greater than 500 nm, good properties are achieved. Preferably, the layer thickness is <1 μm, particularly preferably <500 nm. For example, the HRI layers according to the invention have a value for the sum of light absorption and light scatter of ≦10% at a layer thickness of about 1 μm and with light irradiation at a wavelength of 405 nm. At the same time, such high refractive index lacquer layers are distinguished by very low roughness (surface roughness) of less than 20 nm, determined by means of AFM (atomic force microscopy), and surprisingly good scratch resistances of less than 0.75 μm scratch depth.

Accordingly, the present invention provides a coated product containing a substrate (S), of an organic polymer, and at least one coating containing at least one layer (A), characterised in that it contains finely divided TiO₂ nanoparticles in an amount of from 58 wt.% to 95 wt.%, based on the coating (A).

In the novel layers, the TiO₂ nanoparticles are particularly finely divided, which is shown by the low k value, their good transparency and the low value for the sum of the light absorption and scatter. The transmission of the layers (A) in the visible wavelength range (400-800 nm), even at a thickness of about 1 μm, is preferably more than 70%, in particular more than 75% and most particularly preferably more than 80%.

These novel HRI layers (layer (A)) are highly suitable both for the production of coatings containing a single HRI layer and for the production of coatings containing a multilayer structure of a combination of HRI layers (A) with “low refractive index” LRI layers (B), which are characterised in that their refractive index n (real part) is at least 0.3 unit lower than that of the high refractive index HRI coating, that is to say n (B)≦1.6 and in particular ≦1.5. This layer (B), also referred to here as the “LRI” (low refractive index) layer, is combined alternately with the high refractive index layer (A), so that there are formed on the substrate (S) HRI/LRI layer sequences [(A)-(B)]ₓ, wherein x denotes an integer from 1 to 100.

The coating of a substrate (S) with single layers and/or multilayers can be carried out on one side or on both sides. In the case of coating with multilayers, the first and last layers on the substrate can, independently of one another, be an HRI layer (A) or an LRI layer (B).

The products and processes according to the invention are described further hereinbelow.

Substrate (S):

The material of the substrate (S) is selected from at least one of the group consisting of glass, quartz (which is preferably used for planar waveguides) and organic polymers. From this group, preference is given to organic polymers and, of those, in particular to polycarbonate, poly(methyl) methacrylate, polyesters or cycloolefin polymers.

Polycarbonates for the compositions according to the invention are homopolycarbonates, copolycarbonates and thermoplastic polyester carbonates.

The polycarbonates and copolycarbonates according to the invention generally have mean molecular weights (weight average) of from 2000 to 200,000, preferably from 3000 to 150,000, in particular from 5000 to 100,000, most particularly preferably from 8000 to 80,000, especially from 12,000 to 70,000 g/mol (determined by GPC with polycarbonate calibration).

For the preparation of polycarbonates for the compositions according to the invention, reference may be made, for example, to “Schnell”, Chemistry and Physics of Polycarbonates, Polymer Reviews, Vol. 9, Interscience Publishers, New York, London, Sydney 1964, to D.C. PREVORSEK, B. T. DEBONA and Y. KESTEN, Corporate Research Center, Allied Chemical Corporation, Moristown, N.J. 07960, “Synthesis of Poly(ester) carbonate Copolymers” in Journal of Polymer Science, Polymer Chemistry Edition, Vol. 19, 75-90 (1980), to D. Freitag, U. Grigo, P. R. Müller, N. Nouvertne, BAYER AG, “Polycarbonates” in Encyclopedia of Polymer Science and Engineering, Vol. 11, Second Edition, 1988, pages 648-718 and finally to Dres. U. Grigo, K. Kircher and P. R. Müller “Polycarbonate” in Becker/Braun, Kunststoff-Handbuch, Volume 3/1, Polycarbonate, Polyacetale, Polyester, Celluloseester, Carl Hanser Verlag Munich, Vienna 1992, pages 117-299. The preparation is preferably carried out by the interfacial process or the melt transesterification process.

Preference is given to homopolycarbonates based on bisphenol A and to copolycarbonates based on the monomers bisphenol A and 1,1-bis-(4-hydroxyphenyl)-3,3,5-trimethylcyclohexane. These or other suitable bisphenol compounds are reacted with carbonic acid compounds, in particular phosgene or, in the melt transesterification process, diphenyl carbonate or dimethyl carbonate, to form the respective polymers.

The substrates are most particularly preferably highly transparent substrate sheets, which are produced on a large scale as compact discs (CDs) for optical data storage media. For their production there are used inter alfa polycarbonates of CD quality, for example linear polycarbonate based on bisphenol A, for example the polycarbonate types Makrolon® DP1-1265 (linear bisphenol A polycarbonate having a melt volume flow rate of 19.0 cm³/10 min at 250° C. and under a 2.16 kg load, measured according to ISO 1133) or OD 2015 (linear bisphenol A polycarbonate having a melt volume flow rate of 16.5 cm³/10 min at 250° C. and under a 2.16 kg load, measured according to ISO 1133 and a Vicat softening temperature of 145° C. under a 50 N load and with a heating rate of 50° C. per hour according to ISO 306) from Bayer MaterialScience AG. The substrate (S) can exhibit grooves, depressions and/or elevations arranged in spiral form and can carry on the surface so-called information layers or storage layers, as are conventional in optical data storage media.

HRI layer (A):

The HRI layer (A) is produced from a pouring solution containing the following components:

Nanoparticle suspension: Anhydrous TiO₂ nanoparticle suspensions in an organic solvent, for example isopropanol, are used. An important boundary condition in view of optical requirements is the particle size of the TiO₂ nanoparticles. It has been found that their particle sizes should not exceed values of about 100 nm (d₁₀₀ value, maximum diameter of 100% of the particles, measured by means of analytical ultracentrifugation “AUC”). Advantageously, the d₁₀₀ values are below 70 nm and the d₅₀ values (maximum diameter of 50% of the particles) are below 25 nm. The method of analytical ultracentrifugation for determining the particle size is described, for example, in “Particle Characterization”, Part. Part. Syst. Charact., 1995, 12, 148-157 and is accordingly known to the person skilled in the art. The HRI layer does not contain any ZrO₂ particles.

Such products are marketed, for example, by the Japanese company Tayca, Tokyo under the trade name “Micro Titanium”.

If the TiO₂ nanoparticles are suspended in a low-boiling organic solvent, for example isopropanol (boiling point (b.p.) 82° C.), the solvent should advantageously be exchanged for a higher boiling solvent, the solvent exchange advantageously being carried out by distillation. The higher boiling solvent should have a boiling point greater than or equal to 100° C. Most particular preference is given to higher boiling alcohols such as, for example, diacetone alcohol (DAA, b.p. 166° C.), 1-methoxy-2-propanol (MOP, b.p. 120° C.) or propyl glycol (b.p. 150-152° C.) or mixtures of these solvents.

Binders: Preference is given to the use of UV-reactive monomer components which can be reacted after coating by means of a photochemical reaction to give highly crosslinked polymer matrices. For example, crosslinking is carried out with the aid of UV radiation. Crosslinking with the aid of UV radiation is particularly preferred in view of increased scratch resistance. The reactive components are preferably UV-crosslinkable acrylate systems, as are described, for example, in P. G. Garratt in “Strahlenhartung” 1996, C. Vincentz Vlg., Hannover or BASF Handbuch, Lackiertechnik, A. Goldschmidt, H. Streitberger, Vincentz Verlag, 2002, Chapter Acrylatharze page 119 ff. Particularly preferred binders are polyfunctional acrylates, for example diacrylates, such as hexanediol diacrylate (HDDA) or tripropylene glycol diacrylate (TPGDA), triacrylates, such as pentaerythritol triacrylate, tetraacrylates, such as ditrimethylolpropane tetraacrylate (DTMPTTA), pentaacrylates, such as dipentaerythritol pentaacrylate, or hexaacrylates, such as dipentaerythritol hexaacrylate (DPHA). DPHA in particular is used. In addition to these low molecular weight polyfunctional acrylates it is also possible to use oligomeric or polymeric (meth)acrylates, for example urethane acrylates. Urethane acrylates are prepared from alcohols containing (meth)acryloyl groups, and di- or poly-isocyanates. Preparation processes for urethane acrylates are known in principle and are described, for example, in DE-A-1 644 798, DE-A 2 115 373 or DE-A-2 737 406. Such products are marketed, for example, by Bayer MaterialScience under the name Desmolux®. Of course, mixtures of the mentioned polyfunctional acrylates can also be used.

Solvents: The solvents can be selected from the group consisting of alcohols, ketones, diketones, cyclic ethers, glycols, glycol ethers, glycol esters, N-methylpyrrolidone, dimethylformamide, dimethyl sulfoxide, dimethylacetamide and propylene carbonate. Preference is given to the use of 1-methoxy-2-propanol (methoxy alcohol, MOP) and 4-hydroxy-4-methyl-2-pentanone (diacetone alcohol, DAA), mixtures of these two solvents also preferably being used.

Additives: The components used are preferably at least one additive selected from the group of the photoinitiators and thermnoinitiators. Based on the sum of the parts by weight of the components of the pouring solution, up to 3 parts by weight of additives (A3) are used, preferably from 0.05 to 1 part by weight, particularly preferably from 0.1 to 0.5 part by weight. Typical photoinitiators (UV initiators) are α-hydroxy ketones (Irgacure® 184, Ciba) or monoacylphosphines (Darocure® TPO, Ciba). The amount of energy (energy of the UV radiation) required to initiate the UV polymerisation is in the range of approximately from 0.5 to 4 J/cm², particularly preferably in the range from 2.0 to 3.0 J/cm² of coated surface. There are suitable as further additives also so-called coating additives, as are offered, for example, by Byk/Altana (46483 Wesel, Germany) under the name BYK, for example BYK 344®.

The pouring solution for the high refractive index coatings according to the invention is prepared by dissolving at least one binder and optionally further additives in an organic solvent or solvent mixture. The resulting solution (referred to hereinbelow as the binder solution) is mixed with the above-described nanoparticle suspension, for example with stirring, and optionally filtered and degassed. In a preferred embodiment, the suspension contains the same organic solvent or solvent mixture as the binder solution.

For homogenisation, the pouring solution is optionally treated with ultrasound, for example for up to 5 minutes, preferably for from 10 to 60 seconds, and/or filtered over a filter, preferably having a 0.2 μm membrane (for example an RC membrane from Sartorius).

By using the mentioned TiO₂ nanoparticles and the procedure described here, it is possible to prevent agglomeration of the nanoparticles.

A preferred coating composition contains from 15 to 30 parts by weight, preferably from 17 to 28 parts by weight, particularly preferably from 22 to 27 parts by weight, of the nanoparticles according to the invention, from 2 to 8 parts by weight, preferably from 2.5 to 5 parts by weight, of acrylate-containing binder, from 0 to 3 parts by weight, preferably from 0.05 to 1 part by weight, particularly preferably from 0.1 to 0.5 part by weight, of further additives, from 40 to 80 parts by weight, preferably from 45 to 75 parts by weight, particularly preferably from 55 to 73 parts by weight, of organic solvent, wherein the sum of the parts by weight of the components is normalised to 100.

Based on the cured layer, that is to say after evaporation of the solvent and UV crosslinking, the solids content of TiO₂ nanoparticles in the cured layer is from 58 to 95 wt.%, preferably from 70 to 90 wt.%, in particular from 80 to 90 wt.%.

Process for the production of the coated products:

The pouring solution is applied to the surface of the substrate, that is to say to the surface of the information and storage layer. Suitable coating technologies are the methods known per se, such as flooding, dipping, doctor blade application, spraying, spin coating as well as pouring over slit or cascade coating devices as well as curtain coating devices. These processes are described, for example, in BASF Handbuch, Lackiertechnik A., Goldschmidt, H. Streitberger, Vincenz-Verlag, 2002 Chapter Lackverarbeitung p. 494 ff.

After removal of the excess pouring solution, preferably by centrifugation (spin coating), there remains on the substrate a residue of the pouring solution, the thickness of which is dependent on the solids content of the pouring solution and, in the case of spin coating, on the centrifugation conditions.

The solvent contained in the pouring solution can optionally be removed partially or wholly by heat treatment. Subsequent crosslinking of the polymer components of the pouring solution is preferably carried out by photochemical (for example UV light) methods. Photochemical crosslinking can be carried out, for example, in a UV irradiation system: To that end, the coated substrate is placed on a conveyor belt which is moved past a UV irradiation source (Hg lamp, 80 W) at a speed of about 1 m/min. This process can also be repeated in order to increase the irradiation energy per cm². Preference is given to an irradiation energy of at least 1 J/cm², preferably from 2 to 10 J/cm². The coated substrate can then be subjected to thermal after-treatment, preferably with hot air, for example for from 5 to 30 minutes at from 60° C. to 120° C.

Accordingly, the present invention also provides a process for the production of a product coated with layer (A), comprising the steps

i. coating the product with a pouring solution containing the components
a. an anhydrous suspension of TiO₂ nanoparticles having a d₁₀₀ value of about 100 rim in an organic solvent having a boiling point ≧100° C.,
b. binders,
c. photo- or thermo-initiators,
d. optionally additives, and
e. organic solvent;

ii. removing the excess pouring solution,

iii. removing the solvent,

iv. crosslinking the coating.

By the above-described coating with a single layer (A) there is obtained, in the case of single-sided coating of the substrate (S), a product having the layer sequence (S)-(A) or, in the case of two-sided coating, a product having the layer sequence (A)-(S)-(A). This invention likewise provides such products.

It has been found that these layers have a refractive index ≧1.85, in particular ≧1.90, measured in a wavelength range of from 380 to 420 nm. They are accordingly high refractive index (HRI) layers. By using the mentioned TiO₂ nanoparticles and the procedure described here it is possible to prevent agglomeration of the nanoparticles. As a result, the layers have a low k value. At a wavelength of about 405 run and a layer thickness of 1 μm, the sum of the measured light scatter and absorption, which determines the level of the k value, of the HRI layers according to the invention has a value of less than 10%. It is the case here that, in particular in the nanoparticle-containing systems present here, k and α are dominated in the visible spectral range (400 to 800 nm) by the scatter if the primary nanoparticles are too large or nanoparticles agglomerate to form larger particles, even if there is no molecular absorption in that spectral range. This low value for the sum of light absorption and scatter in the layer shows that the TiO₂ nanoparticles in the HRI layer (A) according to the invention are present in particularly finely divided form and no agglomeration to larger nanoparticles occurs. The layers have high transparency with transmission values of ≧70%, in particular ≧75% and most particularly preferably ≧80% in the visible spectral range.

Surprisingly, it has been found that the above-described high refractive index TiO₂ layers (A) according to the invention, also referred to as “TiO₂ HRI” hereinbelow, can readily be combined with layers (B) consisting of coatings produced from conventional, thermally or photochemically crosslinkable pouring recipes whose refractive index is conventionally in the region of about 1.5. Therefore, in addition to products having the described single-layer high refractive index layers (A), the present application also covers substrates having multilayers comprising alternating layers having a high (MI) and a low (LRI) refractive index, wherein the above-described TiO₂-containing recipes are used for the layers (A).

Layer (B): For the so-called LRI layers (B), preference is naturally given to formulations whose refractive index is as low as possible and which can be coated and crosslinked as analogously as possible to the TiO₂ HRI formulation. There are suitable as the low refractive index layer (LRI) in principle all coating recipes which have a substantially lower refractive index n than the TiO₂ HRI coating (n about 1.90 at 405 nm). The difference Δn should be greater than 0.2, preferably greater than 0.25 and particularly preferably greater than 0.3. Layer (B) has a refractive index ≦1.70, preferably ≦1.65, particularly preferably ≦1.60, measured in a wavelength range of from 380 to 420 nm.

Accordingly, there are suitable as LRI layers all conventional recipes (solutions of binders), that is to say recipes which do not contain refractive-index-increasing components, such as high refractive index nanoparticles. Such recipes are known to the person skilled in the art, for example from “Coatings Compendium, Lackrohstoffkunde by P. Nanetti, Vincentz Verlag, Hanover, 2000”. As described therein, the binders can be, for example, polycondensation resins, for example polyesters, or polyaddition resins, such as polyurethanes, or polymerisation resins, such as poly(meth)acrylates. The systems can crosslink both thermally and by the action of radiation. In addition to binders and solvents, the LRI layer recipes can contain further constituents, such as initiators, rheological additives, flow agents or fillers, wherein the latter must be of such a type that highly transparent layers are formed. Accordingly, there are suitable as fillers only those nanoparticles which, in addition to mechanical and rheological effects, also have refractive-index-lowering properties, for example silica nanoparticles having particle sizes (d₂₅)≦25 nm.

Particularly preferred recipes for the LRI layer (B) include UV-crosslinkable acrylate or polyurethane acrylate binders, which are dissolved in alcoholic solvents and contain as further components inter alia UV initiators and low refractive index silica nanoparticles.

The preparation of silica-containing, UV crosslinkable recipes and coatings therefrom is described, for example, in WO-A 2009/010193.

The production of the coatings from the mentioned recipes for layer (A) and (B) can further be carried out by the processes known to the person skilled in the art. An overview of common production processes is to be found, for example, in BASF-Handbuch, Lackiertechnik, Vincentz-Verlag, 2002, Chapter “Die Beschichtung”, p. 333 ff,″ in Lehrbuch der Lacktechnologie (Brock, Groteklaes, Mischke-Vincentz Verlag, 2nd Edition 2000, page 229 ff) or in Lehrbuch der Lacke und Beschichtungsstoffe, Volume 8—Herstellung von Lacken und Beschichtungsstoffen (Kittel, Hirzel Verlag, 2nd Edition 2005).

The production most commonly takes place with stirring. All the components are thereby introduced into a vessel in succession and homogenised with constant stirring. In order to accelerate the homogenisation process, the mixtures can be heated.

Production of the multilayer coating:

The substrates are coated alternately, for example by means of spin coating, with the coating composition for an HRI layer (A) and coating composition for an LRI layer (B), for example a silica LRI recipe.

Accordingly, the present invention also provides a process for the production of a coated product, wherein the substrate (S) is coated alternately with layers (A) and (B) on one or more sides, one or more times, layer (A) being produced by the above-described process.

Such multilayers can be used as reflection-reducing coatings, as described, for example, in “Vakuum-Beschichtung 4”, Gerhard Kienel, VDI Verlag, 1993. The number of multilayers required can be kept lower, the greater the difference in refractive index betwen the HRI/LRI layers. With regard to the target layer thickness d, the rule-of-thumb formula d=λ/4 divided by n applies. Accordingly, if it is desired to reflect IR heat radiation of wavelength 1000 nm, a desired layer thickness for the HRI layer of n: 1.90 of about 131 nm is obtained, and a desired layer thickness for the HRI layer of n: 1.5 of about 167 mn is obtained.

It is not important whether application of the multilayer series is begun with the HRI or with the LRT recipe, or whether the total number of multilayers is even or odd.

With regard to the substrates for the multilayers, the selection criteria mentioned for the HRI monolayers are suitable in principle, sheets and films of polycarbonate being particularly preferred.

With regard to the coating technology for HRI monolayers or multilayers, the methods known per se, such as flooding, dipping, doctor blade application, spraying as well as pouring over slit or cascade coating devices as well as curtain coating devices, are suitable. These processes are described, for example, in BASF Handbuch, Goldschmidt, Streitberger “Lackiertechnik”, Vincentz, 2002 Chapter Lackverarbeitung, p. 494 ff″.

By means of the above-described coatings containing multilayers of layers (A) and (B) there are obtained, by alternating coating of the substrate (S) on one or more sides, a product having the layer sequence (S)—(B)_{y}—[(A)—(B)]ₓ—(A)_{z} or, in the case of two-sided coating, a product having the layer sequence (A)_{z}—[(B)—(A)]ₓ—(B)_{y}—(S)—(B)_{y}—[(A)—(B)]_{x—A}_{z}, wherein y, z independently of one another can in each case be 0 or 1 and x is an integer from 1 to 100. This invention also provides such products. Very effective IR reflective properties are found in these products according to the invention.

Accordingly, the present application also provides a process for the production of a coated product, comprising at least once the above-described steps i. to iv. for application of a layer (A) and additionally comprising at least once the step

v. application of a layer (B) having a refractive index n 1.65,

wherein when steps i. to v. are carried out several times, layers (A) and (B) are applied alternately.

In a preferred embodiment, substrates of polycarbonate are coated with an alternating sequence of TiO₂ HRI/silica LRI multilayers.

A further field of application of the high refractive index coatings according to the invention, in addition to optical data storage media , is planar waveguides (PWG). A waveguide is defined as an inhomogeneous medium which, by its physical properties, concentrates a wave in such a manner that it is guided therein. The principle of operation is explained in greater detail, for example, in A. W. Snyder and J. D. Love, Optical Waveguide Theory, Chapman and Hall, London (1983).

### EXAMPLES

A) Measuring methods for testing

Determination of the layer thickness is carried out by means of a white light interferometer (ETA SPB-T, ETA Optik GmbH).
Determination of the refractive index:
The refractive index n and the imaginary part k of the complex refractive index (k value of the coating) were obtained from the transmission and reflection spectra. To that end, about 100 to 300 nm thick films of the coating were spin coated from dilute solution onto quartz glass substrates. The direct transmission and reflection of this layer bundle was measured, with exclusion of the transmitted and reflected scattered light, using a spectrometer from STEAG ETA-Optik, CD-Measurement System ETA-RT, and then the layer thickness and the spectral characteristic of n and k were adapted to the measured transmission and reflection spectra. This is carried out using the internal software of the spectrometer and additionally requires the n and k data of the quartz glass substrate, which were determined beforehand in a blind measurement. k is related to the decay constant of the light intensity α as follows:

$$k = \frac{λ \cdot α}{4 π} .$$

λ is the wavelength of the light.
In this measuring arrangement, the direct transmission and reflection is measured, with exclusion of the transmitted and reflected scattered light. As a result, the decay constant α, that is to say k, also contains the components which through scatter lead to the attenuation of the light intensity and not only the components of pure molecular absorption. Accordingly, it is possible, by means of the measuring arrangement, also to determine the sum of absorption and scatter which, in particular in the nanoparticle-containing systems present here, is dominated in the visible spectral range (400 to 800 nm) by the scatter if the primary nanoparticles are too large or nanoparticles agglomerate to form larger particles, even if there is no molecular absorption in that spectral range.
The real part n and the imaginary part k were determined as a function of the wavelength, pronounced wavelength dependency, as expected for high refractive indices, being determined (n: 1.88 to 1.93 in the range from 380 to 420 nm, n: approximately from 1.84 to 1.85 in the region of 550 nm, and n: approximately from 1.820 to 1.825 in the region greater than 800 nm—the scatter of the measured results is the result of multiple determinations).
Surface roughness: The surface roughness was determined by means of AFM (atomic force microscopy) according to standard ASTM E-42.14 STM/AFM, Ra values in the range from 15 to 18 rim being determined
Scratch resistance: In order to determine the scratch resistance, a diamond needle having a tip radius of 50 μm was moved over the coating at a speed of 1.5 cm/s and with an applied weight of 40 g, and the resulting scratch depth was measured. The measured values were in the range of approximately from 0.58 to 0.65.

B) Production of UV-crosslinkable suspensions

### Example 1

Solvent exchange in TiO₂ nanoparticles

Starting product: Micro Titanium/IPA Sol “TiO₂ ND 134” in isopropanol. This is a 45 wt.% nanoparticle suspension from Tayca.

The nanoparticle suspension was concentrated in a rotary evaporator at 15-25 mbar and at a temperature of 35-40° C., isopropanol (b.p. 82° C.) being distilled off. The decreasing volume was replaced by diacetone alcohol (DAA, 4-hydroxy-4-methyl-2-pentanone, Acros, b.p.: 166° C.).

Product: TiO₂-DAA 34.7 wt.% in DAA.

### Example 2

Production of a TiO₂—containing UV-crosslinkable suspension (TiO₂-HRI recipe)

This is the recipe for a layer A according to the invention.

7.5 g of dipentaerythritol penta/hexaacrylate (DPHA, Aldrich 407283) were weighed into a 250 ml glass beaker. 39.4 g of diacetone alcohol (DAA) were added thereto and the mixture was stirred by means of a magnetic stirrer, a clear solution forming. 0.54 g of Irgacure® 184 (1-hydroxycyclohexylbenzophenone from Ciba) was added and stirring was carried out until a clear solution formed. 131.3 g of the TiO₂—DAA nanoparticle suspension prepared according to Example 1 were added, with stirring, a translucent suspension being obtained.

Before being used, the nanoparticle-containing solution was homogenised with an ultrasonic finger and filtered over a 0.45 μm filter.

### Example 3

Preparation of an SiO₂-containing UV-crosslinkable suspension (SiO₂-LRI recipe)

A UV-crosslinkable recipe having a high content of silica nanoparticles was prepared. Such recipes are contained in application WO-A 2009/010193.

1.5 g of DPHA (dipentaerythritol penta/hexaacrylate, Aldrich, 407283),

1.5 g of PETA (pentaerythritol triacrylate, Aldrich, 246794),

7.0 g of Desmolux U 100 (urethane acrylate, Bayer MaterialScience),

0.4 g of Irgacure 184 ((1 -hydroxycyclohexylbenzophenone, CIBA),

0.1 g of Darocure TPO (diphenyl(2,4,6-trimethylbenzoyl)-phosphine oxide),

83.6 g of Highlink Nano 401-31, 13 tun silica nanoparticles, 29.8% in methoxypropanol (MOP) from Clariant,

0.17g of Na dioctylsulfosuccinate (anionic surfactant, Fluka 86139) and

48.0 g of methoxypropanol (1-methoxy-2-propanol, MOP, KMF 12-512)

were homogenised by stirring. Before being used, the nanoparticle-containing suspension was homogenised with an ultrasonic finger and filtered over a 0.45 μm filter.

C) Coating of quartz substrates in order to determine the optical properties (n, k)

Production of a coated sheet with a coating layer thickness >120 nm:

With the aid of a spin coater (Steag Hamatech), the nanoparticle suspensions described in the above examples were each applied at a speed of rotation of 10,000 min⁻¹(revolutions per minute) to a 2.5×2.5 cm glass substrate (quartz specimen slide) and then crosslinked with UV light (Hg lamp, about 3 J/cm²).

### Example 4

Optical properties and layer thickness of the TiO₂-HRI coating of Example 2

The following values were determined using the methods described in A) on a quartz substrate coated according to C) with the coating of Example 2:

layer thickness: 156.3 nm

refractive index: n: 1.936

k value: 0.002

### Example 5

Optical properties and layer thickness of the SiO₂-LRI coating of Example 3

The following values were determined using the methods described in A) on a quartz substrate coated according to C) with the coating of Example 3:

refractive index n: 1.485

layer thickness: 337.4 mn

k value: 0.015

D) Coating of compact disc (CD) substrates

In order to determine the scratch resistance of the coating on plastics substrates and in order to determine the sum of absorption and scatter of the coating according to the invention of Example 2 in a coating layer thickness of about 1 μm (accuracy +/−10%), the formulations described in Examples 2 and 3 were applied under the following spin coating conditions to CD substrates of Makrolon® OD2015 (linear bisphenol A polycarbonate having a melt volume flow rate of 16.5 cm³/10 min at 250° C. and under a 2.16 kg load, measured according to ISO 1133 and a Vicat softening temperature of 145° C. under a 50 N load and with a heating rate of 50° C. per hour according to ISO 306):
metering of the pouring solutions at 50 min⁻¹ (revolutions per minute), distribution of the sample at 10 min⁻¹ (revolutions per minute) over a period of 60 sec., centrifugation at 3000 min⁻¹ (revolutions per minute) for a period of 15 sec.
The coating was crosslinked with a Hg lamp at 5.5 J/cm².
The layer thickness and scratch resistance were then determined by the methods described in A).

### Example 6

Properties of the TiO₂-containing HRI coating of Example 2

The following values were determined using the methods described in A) on a polycarbonate substrate coated according to D) with the coating of Example 2:

surface roughness Ra: 12 to 18 nm determined by means of AFM

scratch depth: 0.6 to 0.65 μm

sum of absorption and scatter at a wavelength of 405 nm: about 6.5%

### Example 7

Properties of the SiO₂-containing LRI coating of Example 3

The following values were determined using the methods described in A) on a polycarbonate substrate coated according to C) with the coating from Example 2:

surface roughness Ra: 10 to 15 nm determined by means of AFM

scratch depth: 0.5 to 0.6 μm

### Example 8

Coating of compact disc (CD) substrates with TiO₂-HRI/SiO₂-HRI multilayers

a) Coating of the first TiO₂-HRI layer

The recipe described in Example 2 was applied via a metering syringe to the CD substrate (Makrolon OD 2015) with the aid of a fully automatic spin coater from Steag Hamatech, equipped with a pressure-operated metering device EFD 2000 XL. The spin conditions (removal of the excess lacquer by centrifugation) were so chosen that a layer thickness of about 125 nm was obtained. To that end, the speed of rotation of the substrate was set at 240 min⁻¹ (revolutions per minute) for 2.1 s, at 1000 min⁻¹ (revolutions per minute) for 3 s and then at 7200 min⁻¹ (revolutions per minute) for 17 s. Crosslinking was then carried out using a Hg lamp at 5.5 J/cm².

b) Coating of the first SiO₂-HRI layer onto the first TiO₂-HRI layer

The SiO₂-LRI formulation described in Example 3 was coated and UV-crosslinked analogously to a), but the coating conditions were oriented towards layer thicknesses of about 190 nm. In detail, the following conditions were maintained for the centrifugation: 2.1 s at 240 min⁻¹ (revolutions per minute), 1.5 s at 1000 min⁻¹ (revolutions per minute) and 13 s at 7000 min⁻¹ (revolutions per minute).

c) Application of the further multilayers

The procedures described in a) and b) were repeated, a spectroscopic evaluation according to ASTM E 1331 (Standard Test Method for Reflectance Factor and Color by Spectrophotometry Using Hemispherical Geometry) being carried out in each case after a total number of 16 and 24 multilayers. This showed that the CD substrate provided with 16 multilayers exhibited a reflection peak reaching 72% in the range from 900 to 1150 nm, that is to say in the infrared range, while a reflection of about 92% was achieved after 24 multilayers.

The alternating sequence of the darker HRI and lighter LRI layers could also be documented graphically by means of TEM (transmission electron microscopy) images.

1.-14. (canceled)

15. A coated product comprising a substrate (S), of an organic polymer, and at least one coating comprising at least one layer (A), which comprises finely divided TiO₂ nanoparticles in an amount of from 58 to 95 wt.%, based on the coating (A).

16. The coated product according to claim 15, comprising from 80 to 90 wt.% of the TiO₂ nanoparticles, based on the coating (A).

17. The coated product according to claim 15, wherein the at least one layer (A) has a layer thickness of greater than 120 nm.

18. The coated product according to claim 15, wherein the at least one layer contains no further nanoparticles apart from the TiO₂ nanoparticles.

19. The coated product according to claim 15, wherein at a wavelength of 405 nm, the at least one layer (A) has a value for the sum of light absorption and scatter of less than or equal to 10%.

20. An optical data storage medium obtained from the coated product according to claim 15.

21. The coated product according to claim 15, wherein the at least one layer (A) is obtained from a coating composition comprising
i. an anhydrous suspension of TiO₂ nanoparticles having a d₁₀₀ value of less than or equal to about 100 nm in an organic solvent having a boiling point greater than or equal to 100° C.,
ii. a binder,
iii. a photo- or thermo-initiator,
iv. optionally additives, and
v. an organic solvent

22. The coated product according to claim 15, wherein the product has the layer sequence (S)—(A) or (A)— (S)—(A), measured in a wavelength range of from 380 to 420 nm.

23. The coated product according to claim 15, wherein at least one coating additionally comprises at least one further layer (B) which has a refractive index n less than or equal to 1.65, measured in a wavelength range of from 380 to 420 nm.

24. The coated product according to claim 15, wherein the substrate (S) comprises an organic polymer selected from the group consisting of polycarbonate, poly(methyl) methacrylate, polyester and cycloolefin polymer.

25. The coated product according to claim 22, wherein the binder is selected from the group consisting of polyfunctional acrylates.

26. A process for the production of the coated product according to claim 15 containing a layer (A), comprising the steps for application of a layer (A)
i. coating a substrate (S), of an organic polymer, with a pouring solution comprising the components
a. an anhydrous suspension of TiO₂ nanoparticles having a d₁₀₀ value of less than or equal to about 100 nm in an organic solvent having a boiling point greater than or equal to 100° C.,
b. a binder,
c. a photo- or thermo-initiator,
d. optionally additives, and
e. an organic solvent;
ii. removing excess pouring solution,
iii. removing the organic solvent, and
iv. crosslinking the coating.

27. A coating composition for the coating of a substrate (S), of organic polymers comprising
i. an anhydrous suspension of TiO₂ nanoparticles having a d₁₀₀ value of less than or equal to about 100 nm in an organic solvent having a boiling point greater than or equal to 100° C.,
ii. a binder,
iii. a photo- or thermo-initiator,
iv. optionally additives, and
v. an organic solvent.

28. The coated product according to claim 15, wherein the coated product does not contain an antireflection layer.
